(19) United States
(12) Patent Application Publication
(10) Pub. No.: US 2009/0160316 A1
(43) Pub. Date: Jun. 25, 2009

(54) PHOSPHORS AND LIGHTING APPARATUS USING THE SAME

(76) Inventors: Teng-Ming CHEN, Hsinchu City (TW); Po-Ju Chen, Hsinchu City (TW)

Correspondence Address: SINORICA, LLC, 2275 Research Blvd., Suite 500, ROCKVILLE, MD, 20850, US

(21) Appl. No.: 12/250,709

(22) Filed: Oct. 14, 2008

(30) Foreign Application Priority Data
Dec. 20, 2007 (TW) 096149066

(51) Int. Cl. H01J 1/63; C01F 17/00

(52) U.S. Cl. 313/503; 423/263

(57) ABSTRACT

A phosphor has a chemical formula of: (X₁₋ₘEuₘ)₄Y(BO₃)₃, wherein X is at least one of the group consisting of Ca, Sr and Ba, and Y is at least one of the group consisting of Li, Na and K, while 0<m≦0.5.

### BACKGROUND OF THE INVENTION

1. Technical Field

The present invention relates to phosphors and, more particularly, to phosphors to be used in a lighting apparatus.

2. Description of Related Art

Semiconductor lighting apparatuses include light-emitting diodes (LEDs) and laser diodes. Semiconductor lighting apparatuses which provide ultraviolet or near ultraviolet light can be used in combination with different phosphors to make various kinds of light sources.

Of all the new products in the LED industry, white light-emitting diodes are the most promising ones because they provide such advantages as having a small size, low heat generation, low energy consumption and long glowing persistence. Therefore, white light-emitting diodes can be used to replace fluorescent lamps and back lights of flat-panel displays. The so-call “white light” is in fact a combination of lights of different colors having various wavelengths. A white light visible to human eyes must comprise a combination of at least two color lights, such as a combination of blue and yellow lights or a combination of green, blue and red lights.

Presently, most of the commoditized white-light lighting apparatuses generate a white light by using a phosphor powder of Y₃Al₅O₁₂:Ce (YAG:Ce), which emits a yellow light when excited by a blue light, combined with a blue LED. This commoditized, yellow-light phosphor powder is prepared through a solid-state sintering reaction at a high temperature ranging from 1400° to 1600°, and can be excited by a blue LED having an emission wavelength of 467 nm to produce a yellow light having an emission wavelength of 550 nm, whose CIE chromatic coordinate is (0.48, 0.50).

This yellow-emitting phosphor powder for using with a blue LED has to be synthesized under a strict condition, e.g., through a solid-state sintering reaction at a relatively high temperature, and emits light that lacks a blue light component, so as to show a poor color rendering property when used in a white-light lighting apparatus.

### BRIEF SUMMARY OF THE INVENTION

A primary objective of the present invention is to provide a series of phosphors having novel compositions.

A second objective of the present invention is to provide a series of phosphors that emit a yellow light and a yellow-orange light when excited.

A third objective of the present invention is to provide a series of phosphors whose compositions can be adjusted to change colors of emitting lights.

A fourth objective of the present invention is to provide a series of phosphors prepared at medium and low temperatures.

A fifth objective of the present invention is to provide a lighting apparatus, wherein a semiconductor light source is used in combination with a phosphor.

To achieve these ends, the present invention provides a series of phosphors having a general chemical formula of: (X₁₋ₘEuₘ)₄Y(BO₃)₃, wherein X is at least one of the group consisting of Ca, Sr and Ba, and Y is at least one of the group consisting of Li, Na and K, while 0<m≦0.5.

The present invention also provides a lighting apparatus comprising a semiconductor light source and a phosphor, wherein the phosphor has a general chemical formula of: (X₁₋ₘEuₘ)₄Y(BO₃)₃, wherein X is at least one of the group consisting of Ca, Sr and Ba, and Y is at least one of the group consisting of Li, Na and K, while 0<m≦0.5.

### BRIEF DESCRIPTION OF THE SEVERAL VIEWS OF THE DRAWINGS

The invention as well as a preferred mode of use, further objectives and advantages thereof will best be understood by reference to the following detailed description of an illustrative embodiment when read in conjunction with the accompanying drawings, wherein:

FIG. 1 shows X-ray powder diffraction patterns of (Sr_{0.98}Eu_{0.02})₄Li(BO₃)₃ according to a first preferred embodiment of the present invention;

FIG. 2 shows X-ray powder diffraction patterns of (Sr_{0.98}Eu_{0.02})₄Na(BO₃)₃ according to a second preferred embodiment of the present invention;

FIG. 3 shows X-ray powder diffraction patterns of (Ba_{0.98}Eu_{0.02})₄Na(BO₃)₃ according to a third preferred embodiment of the present invention;

FIG. 4 shows excitation and emission spectra of (Sr_{0.98}Eu_{0.02})₄Li(BO₃)₃ according to the first preferred embodiment of the present invention;

FIG. 5 shows excitation and emission spectra of (Sr_{0.98}Eu_{0.02})₄Na(BO₃)₃ according to the second preferred embodiment of the present invention;

FIG. 6 shows excitation and emission spectra of (Ba_{0.98}Eu_{0.02})₄Na(BO₃)₃ according to the third preferred embodiment of the present invention;

FIG. 7 shows a comparison of excitation and emission spectra between (Sr_{0.98}Eu_{0.02})₄Li(BO₃)₃ according to the first preferred embodiment of the present invention and a YAG:Ce product;

FIG. 8 shows a comparison of excitation and emission spectra between (Sr_{0.98}Eu_{0.02})₄Na(BO₃)₃ according to the second preferred embodiment of the present invention and the YAG:Ce product;

FIG. 9 shows a comparison of excitation and emission spectra between (Ba_{0.98}Eu_{0.02})₄Na(BO₃)₃ according to the third preferred embodiment of the present invention and the YAG:Ce product; and

FIG. 10 shows a comparison of CIE chromaticity coordinates among the phosphors according to the preferred embodiments of the present invention.

### DETAILED DESCRIPTION OF THE INVENTION

A detailed description of the present invention will be given below with reference to preferred embodiments thereof, so that one skilled in the art can readily understand features and functions of the present invention from the content disclosed herein. The present invention can be carried out or applied in other embodiments, where changes and modifications can be made to the details disclosed herein from a viewpoint different from that adopted in this specification without departing from the spirit of the present invention.

Phosphors according to the present invention are prepared through a solid-state reaction at a high temperature. A preferred embodiment of the present invention is (Ba_{0.98}Eu_{0.02})₄Na(BO₃)₃, which is prepared by a method comprising the following steps. To begin with, barium carbonate (BaCO₃), europium sesquioxide (Eu₂O₃), sodium carbonate (Na₂CO₃) and boric acid (B(OH)₃) are weighed stoichiometrically, followed by being thoroughly mixed and ground. Then the resultant mixture is put into a crucible and placed in a high-temperature furnace to be sintered in air at a temperature ranging from about 800° C. to about 1000° C. for several hours. The final product is a phosphor provided by the present invention.

In the method described above, barium carbonate (BaCO₃) can be replaced by various metal salts such as calcium carbonate (CaCO₃) or strontium carbonate (SrCO₃), while sodium carbonate (Na₂CO₃) can also be replaced by various metal salts such as lithium carbonate (Li₂CO₃) or potassium carbonate (K₂CO₃). Accordingly, using different metal salts may produce the phosphors of the present invention, i.e., (X₁₋ₘEuₘ)₄Y(BO₃)₃, wherein X is at least one of the group consisting of Ca, Sr and Ba, and Y is at least one of the group consisting of Li, Na and K, while 0<m≦0.5.

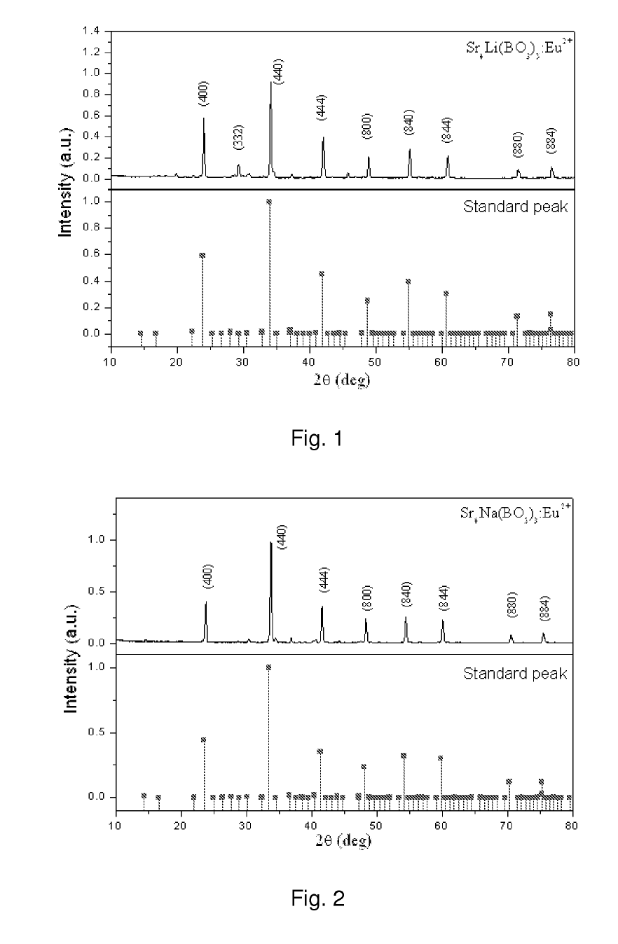

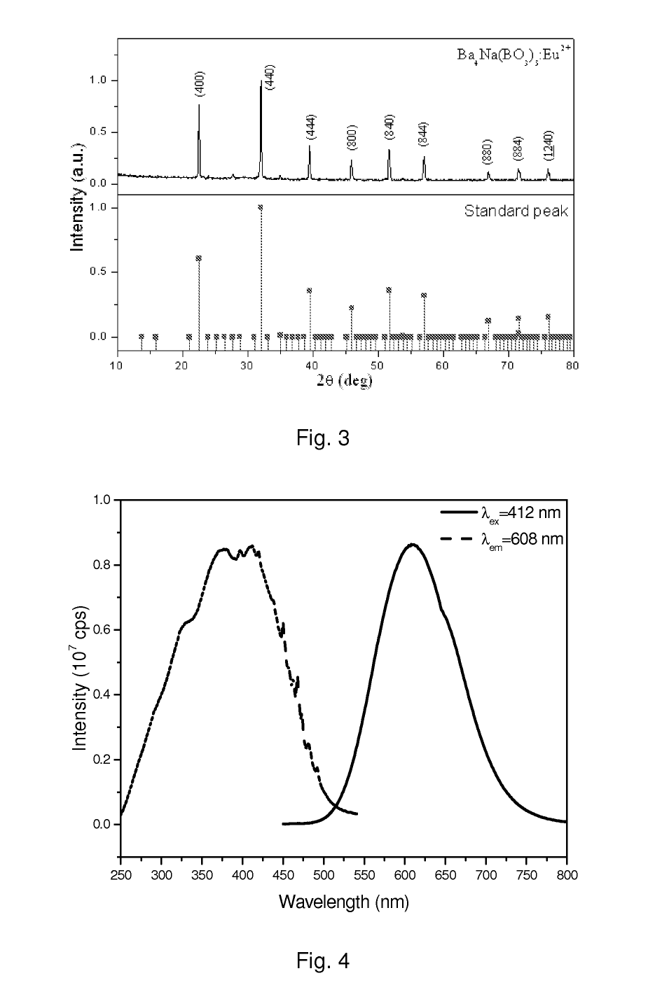

The above-mentioned method was used to prepare (Sr_{0.98}Eu_{0.02})₄Li(BO₃)₃, (Sr_{0.98}Eu_{0.02})₄Na(BO₃)₃ and (Ba_{0.98}Eu_{0.02})₄Na(BO₃)₃, whose X-ray powder diffraction patterns are shown in FIGS. 1, 2 and 3, respectively. According to the results of crystalline phase analysis using X-ray diffraction, the phosphors synthesized according to the present invention were found to be single-phased and no impurities were found therein.

FIG. 4 shows the excitation and emission spectra of (Sr_{0.98}Eu_{0.02})₄Li(BO₃)₃ according to a first preferred embodiment of the present invention. The excitation wavelength shown here ranges from about 300 nm to about 450 nm, which spans across the ultraviolet region, the near-ultraviolet region, and the blue region, wherein the optimal excitation wavelength is about 412 nm, which is a violet-blue light. The emission wavelength also shown in FIG. 4 ranges from about 500 nm to about 650 nm, wherein a major emission peak occurs at a wavelength of about 608 nm, which is a yellow-orange light.

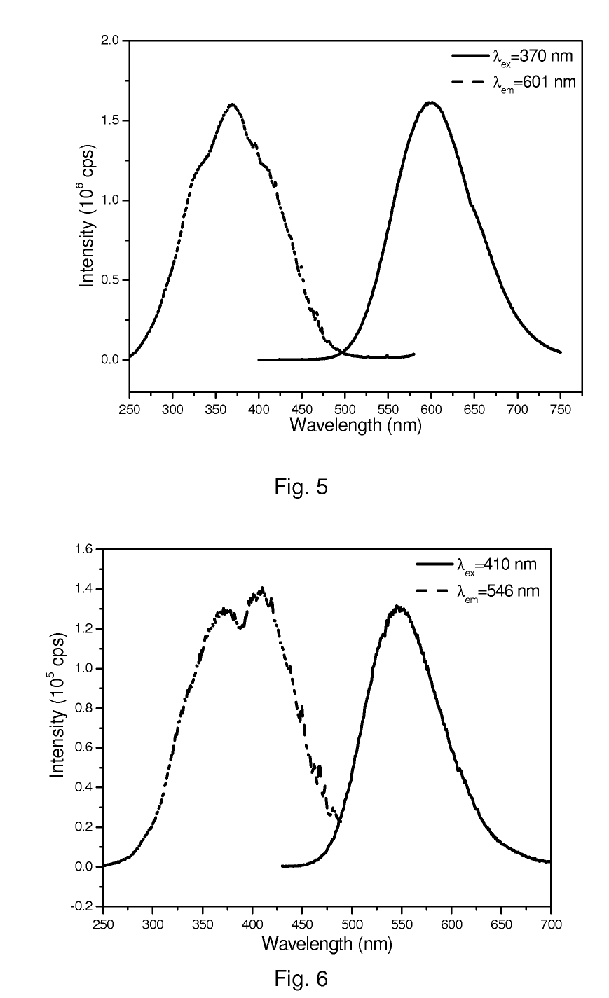

FIG. 5 shows the excitation and emission spectra of (Sr_{0.98}Eu_{0.02})₄Na(BO₃)₃ according to a second preferred embodiment of the present invention. The excitation wavelength shown here ranges from about 300 nm to about 450 nm, which spans across the ultraviolet region, the near-ultraviolet and the blue light regions, wherein the optimal excitation wavelength is about 370 nm, which is an ultraviolet light. The emission wavelength also shown in FIG. 5 ranges from about 500 nm to about 650 nm, wherein a major emission peak takes place at about 601 nm, which is a yellow-orange light.

FIG. 6 shows the excitation and emission spectra of (Ba_{0.98}Eu_{0.02})₄Na(BO₃)₃ according to a third preferred embodiment of the present invention. The excitation wavelength shown here ranges from about 300 nm to about 450 nm, which spans across the ultraviolet regions, the near ultraviolet and the blue regions, wherein the optimal excitation wavelength is about 410 nm, which is a blue light. Also shown in FIG. 6, the emission wavelength ranges from about 500 nm to about 650 nm, wherein a major emission peak occurs at about 546 nm, which is a yellow light.

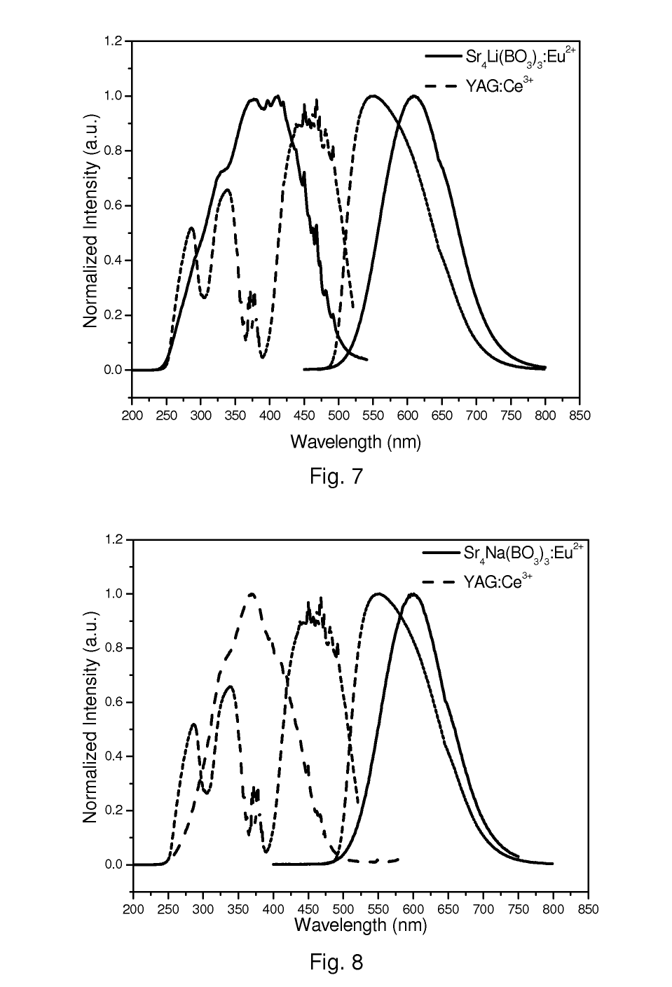

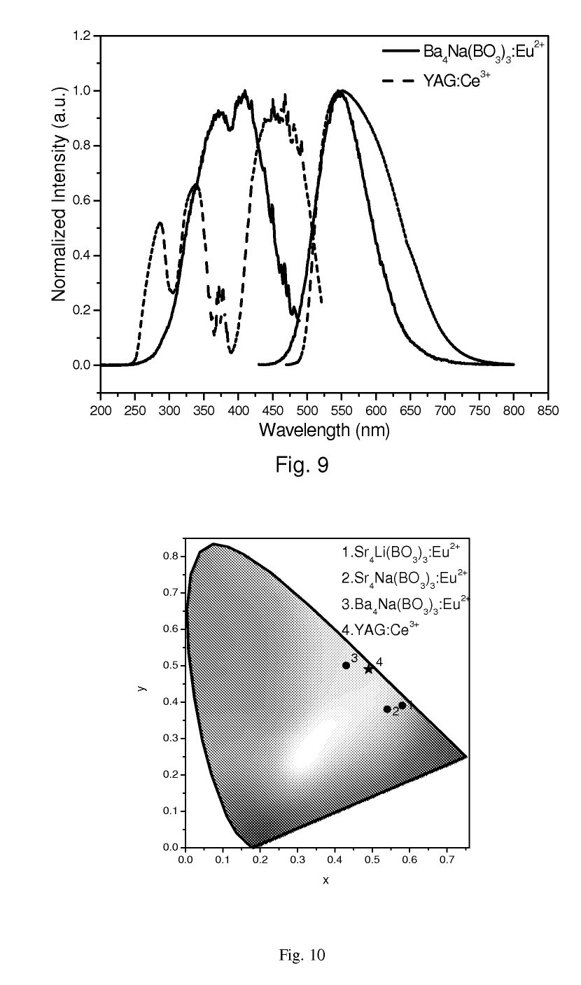

FIGS. 7, 8 and 9 show a comparison of excitation and emission spectra between a YAG:Ce product and the phosphors according to the present invention, namely (Sr_{0.98}Eu_{0.02})₄Li(BO₃)₃, (Sr_{0.98}Eu_{0.02})₄Na(BO₃)₃ and (Ba_{0.98}Eu_{0.02})₄Na(BO₃)₃, respectively. The intensities of emitting light have been normalized so as to compare the waveforms and wavelengths of the emitting lights. As shown in FIGS. 7, 8 and 9, the phosphors provided by the present invention have emission wavelengths similar to those of the YAG:Ce. Besides, compositions of the phosphors of the present invention can be adjusted to modify the colors of emitting lights. On the other hand, the phosphors of the present invention have the excitation wavelengths ranging from about 300 nm to about 450 nm as well as complete waveforms. The phosphors can therefore also be used in combination with commercially available semiconductor radiation sources, which emit ultraviolet light or blue light, to form lighting apparatuses.

When excited by a blue, near-ultraviolet or ultraviolet light, the phosphors according to the present invention emit a yellow or yellow-orange light, whose CIE chromaticity coordinates have an x-coordinate ranging approximately from 0.43 to 0.58 and a y-coordinate ranging approximately from 0.38 to 0.50. FIG. 10 shows the comparison of CIE chromaticity coordinates of the phosphors according to the preferred embodiments of the present invention, wherein (Sr_{0.98}Eu_{0.02})₄Li(BO₃)₃ emits a yellow-orange light having a chromaticity coordinate of (0.58, 0.39) when excited by a radiation source having a wavelength of 412 nm; (Sr_{0.98}Eu_{0.02})₄Na(BO₃)₃ emits a yellow-orange light having a chromaticity coordinate of (0.54, 0.38) when excited by a radiation source having a wavelength of 370 nm; and (Ba_{0.98}Eu_{0.02})₄Na(BO₃)₃ emits a yellow light having a chromaticity coordinate of (0.43, 0.50) when excited by a radiation source having a wavelength of 410 nm.

The phosphors according to the present invention can be applied to a lighting apparatus comprising a semiconductor light source such as an LED or a laser diode. Said semiconductor light source emits an ultraviolet light, a near ultraviolet light or a blue light. When an appropriate semiconductor light source is used in combination with the phosphors of the present invention, both lights emitted by the semiconductor light source and the phosphors are mixed into a white light suitable for a white-light lighting apparatus.

In summary, the phosphors according to the present invention have novel compositions, can be prepared at a low temperature (lower than 1000° C.), have broad excitation spectral ranges (from the ultraviolet zone to the blue light zone) and can therefore be used in combination with the ultraviolet or blue LED chips which is commercially available to form a lighting apparatus. Furthermore, by adjusting the compositions of the phosphors according to the present invention, the emission wavelength changes and spans from a yellow light region to a yellow-orange light region. Therefore, as compared with that of the YAG:Ce commodity, the phosphors according to the present invention are more suitable for a white-light lighting apparatus requiring a high color rendering property.

The preferred embodiments of the present invention have been provided for illustrative purposes only and are not intended to limit the scope of the present invention in any way. Moreover, as the content disclosed herein should be readily understood and can be implemented by a person skilled in the art, all equivalent changes or modifications which do not depart from the spirit of the present invention are encompassed by the appended claims.

1. A phosphor having a chemical formula of:
(X₁₋ₘEuₘ)₄Y(BO₃)₃,
wherein X is at least one of the group consisting of Ca, Sr and Ba, and Y is at least one of the group consisting of Li, Na and K, while 0<m≦0.5.

2. The phosphor as claimed in claim 1, wherein the phosphor can be excited by an ultraviolet light, a near-ultraviolet light or a blue light.

3. The phosphor as claimed in claim 1, wherein the phosphor can be excited by a radiation source having a wavelength ranging from about 300 nm to about 450 nm.

4. The phosphor as claimed in claim 2, wherein the phosphor has an emission wavelength ranging from a yellow light region to a yellow-orange light region when excited.

5. The phosphor as claimed in claim 2, wherein the phosphor has an emission wavelength ranging from about 500 nm to about 650 nm when excited.

6. The phosphor as claimed in claim 2, wherein the phosphor, when excited, emits a light having a chromaticity coordinate comprising an x-coordinate ranging approximately from 0.43 to 0.58 and a y-coordinate ranging approximately from 0.38 to 0.50.

7. The phosphor as claimed in claim 3, wherein the phosphor, when excited, emits a light that mixes with a light emitted by the radiation source into a white light, and the chromaticity coordinate of the phosphor comprising an x-coordinate ranging approximately from 0.43 to 0.58 and a y-coordinate ranging approximately from 0.38 to 0.50.

8. The phosphor as claimed in claim 1, wherein the phosphor is prepared through a solid-state reaction in air at a temperature ranging from about 800° C. to about 1000° C.

9. A lighting apparatus comprising:
a semiconductor light source; and
a phosphor which can be excited by the semiconductor light source and has a chemical formula of:
(X₁₋ₘEuₘ)₄Y(BO₃)₃,
wherein X is at least one of the group consisting of Ca, Sr and Ba, and Y is at least one of the group consisting of Li, Na and K, while 0<m≦0.5.

10. The lighting apparatus as claimed in claim 9, wherein the phosphor can be excited by an ultraviolet light, a near-ultraviolet light or a blue light.

11. The lighting apparatus as claimed in claim 9, wherein the phosphor can be excited by a radiation source having a wavelength ranging from about 300 nm to about 450 nm.

12. The lighting apparatus as claimed in claim 10, wherein the phosphor has an emission band ranging from a yellow light region to a yellow-orange light region when excited.

13. The lighting apparatus as claimed in claim 10, wherein the phosphor has an emission band ranging from about 500 nm to about 650 nm when excited.

14. The lighting apparatus as claimed in claim 10, wherein the phosphor, when excited, emits a light having a chromaticity coordinate comprising an x-coordinate ranging approximately from 0.43 to 0.58 and a y-coordinate ranging approximately from 0.38 to 0.50.

15. The lighting apparatus as claimed in claim 11, wherein the phosphor, when excited, emits a light that mixes with a light emitted by the semiconductor light source into a white light, and the chromaticity coordinate of the phosphor comprising an x-coordinate ranging approximately from 0.43 to 0.58 and a y-coordinate ranging approximately from 0.38 to 0.50.

16. The lighting apparatus as claimed in claim 9, wherein the phosphor is prepared through a solid-state reaction in air at a temperature ranging from about 800° C. to about 1000° C.

17. The lighting apparatus as claimed in claim 9, wherein the semiconductor light source comprises a light-emitting diode.

18. The lighting apparatus as claimed in claim 9, wherein the semiconductor light source comprises a laser diode.

19. The lighting apparatus as claimed in claim 9, wherein the semiconductor light source emits an ultraviolet light, a near-ultraviolet light or a blue light.
